(19) United States
(12) Patent Application Publication
(10) Pub. No.: US 2022/0267208 A1
(43) Pub. Date: Aug. 25, 2022

(54) PRODUCTION OF SUPPLEMENTARY CEMENTITIOUS MATERIALS THROUGH WET CARBONATION METHOD

(71) Applicant: Solidia Technologies, Inc., Piscataway, NJ (US)

(72) Inventors: Vahit Atakan, West Windsor, NJ (US); Sadananda Sahu, Tallahassee, FL (US); Mario Jorge Davidson, Somerset, NJ (US); Alexander Wren Pelham-Webb, Helmetta, NJ (US); Ahmet Cuneyt Tas, Piscataway, NJ (US); Deepak Ravikumar, South Plainfield, NJ (US); Jitendra Arunchandra Jain, Piscataway, NJ (US)

(21) Appl. No.: 17/675,777

(22) Filed: Feb. 18, 2022

Related U.S. Application Data
(60) Provisional application No. 63/151,971, filed on Feb. 22, 2021.

(51) Int. Cl. C04B 7/345; C04B 7/02; C04B 7/32; C04B 14/04

(52) U.S. Cl. CPC C04B 7/3453; C04B 7/02; C04B 7/323; C04B 14/04

(57) ABSTRACT

A method of making a supplementary cementitious material is described that includes: forming a slurry comprising water and a carbonatable material powder, wherein a weight ratio of water to the carbonatable material powder is at least 1; and flowing a gas comprising carbon dioxide into the slurry for 0.5 to 24 hours while maintaining the slurry at a temperature of 1° C. to 99° C. to form a carbonated slurry comprising CaCO₃ and amorphous silica. A method of forming cement or concrete using the supplemental cementitious material is also described.

The present application claims priority to and the benefit of U.S. Provisional Application No. 63/151,971 filed on Feb. 22, 2021, the entire contents of which are incorporated herein by reference.

### FIELD

The present application is directed to the preparation of carbonated supplementary cementitious materials, the carbonated supplementary cementitious materials produced thereby, and uses of the same.

### BACKGROUND

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

The production of ordinary Portland cement (OPC) is a very energy-intensive process and a major contributor to greenhouse gas emissions. The cement sector is the third largest industrial energy consumer and the second largest CO₂ emitter of total industrial CO₂ emissions. World cement production reached 4.1 Gt in 2019 and is estimated to contribute about 8% of total anthropogenic CO₂ emissions.

In an attempt to combat climate change, the members of the United Nations Framework Convention on Climate Change (UNFCC), through the Paris Agreement adopted in December 2015, agreed to reduce CO₂ emissions by 20% to 25% in 2030. This represents an annual reduction of 1 giga ton CO₂. Under this agreement, the UNFCC agreed to keep the global temperature rise within 2° C. by the end of this century. To achieve this goal, the World Business Council for Sustainable Development (WBCSD) Cement Sustainability Initiative (CSI) developed a roadmap called “Low-Carbon Transition in Cement Industry” (WBCSD-CSI). This roadmap identified four carbon emissions reduction levers for the global cement industry. The first lever is improving energy efficiency by retrofitting existing facilities to improve energy performance. The second is switching to alternative fuels that are less carbon intensive. For example, biomass and waste materials can be used in cement kilns to offset the consumption of carbon-intensive fossil fuels. Third is reduction of clinker factor or the clinker to cement ratio. Lastly, the WBCSD-CSI suggests using emerging and innovative technologies such as integrating carbon capture into the cement manufacturing process.

Thus, there is a need for improved cement production that reduces CO₂ emissions; and, therefore, reduces the global effect of climate change. The present disclosure attempts to address these problems, as identified by the EPA and the UNFCCC, by developing a method of integrating carbon capture into the cement manufacturing process.

For instance, Solidia Technologies Inc. has developed a low CO₂ emissions clinker that reduces the CO₂ emissions by 30%. However, a need exists to integrate such materials into conventional hydraulic concrete materials in order to reduce the clinker factor in hydraulic cements such as ordinary Portland cement (OPC), and to further boost the positive environmental potential through the use of such low CO₂ emissions materials as supplementary cementitious materials (SCM). While certain aspects of conventional technologies have been discussed to facilitate disclosure of the invention, Applicants in no way disclaim these technical aspects, and it is contemplated that the claimed invention may encompass or include one or more of the conventional technical aspects discussed herein.

### SUMMARY

It has been discovered that the above-noted deficiencies can be addressed, and certain advantages attained, by the present invention. For example, the methods, and compositions of the present invention provide a novel approach to pre-carbonate a carbonatable clinker, preferably but not exclusively a low CO₂ emission clinker, before adding it to a hydraulic cement as a supplementary cementitious material (SCM), thereby both reducing the clinker factor of conventional hydraulic cements and concretes, and incorporating carbon capture into the production of the conventional hydraulic cement or concrete material, thus providing a doubly positive environmental benefit.

It should be understood that the various individual aspects and features of the present invention described herein can be combined with any one or more individual aspect or feature, in any number, to form embodiments of the present invention that are specifically contemplated and encompassed by the present invention.

According to certain aspects, the present invention provides a method of making a supplementary cementitious material comprising: forming a slurry comprising water and a carbonatable material powder, wherein a weight ratio of water to the carbonatable material powder is at least 1; flowing a gas comprising carbon dioxide into the slurry for 0.5 to 24 hours while maintaining the slurry at a temperature of about 1° C. to about 99° C., or 30° C. to about 95° C., or about 30° C. to about 70° C.; optionally drying the slurry at a temperature of 60° C. to 125° C. for 5 to 24 hours; and optionally subjecting the dried slurry to one or more of deagglomeration and grinding to form the supplementary cementitious material.

According to a further aspect, the present invention provides a method of making a supplementary cementitious material comprising: forming a slurry comprising water and a carbonatable material powder, wherein a weight ratio of water to the carbonatable material powder in the slurry is at least 1; and flowing a gas comprising carbon dioxide into the slurry for 0.5 to 24 hours while maintaining the slurry at a temperature of 1° C. to 99° C. to form a carbonated slurry comprising CaCO₃ and amorphous silica.

According to yet another aspect, the present invention provides a method for forming cement or concrete, the method comprising: forming a supplementary cementitious material according to the methods described above and herein; combining the supplementary cementitious material with a hydraulic cement composition to form a mixture, wherein the mixture comprises 1%-99%, by weight of the supplementary cementitious material, based on the total weight of solids in the mixture; and reacting the mixture with water to form the cement or concrete.

### BRIEF DESCRIPTION OF THE DRAWINGS

These and other features of this invention will now be described with reference to the drawings of certain embodiments which are intended to illustrate and not to limit the invention.

FIG. 1 is a schematic illustration of an exemplary microstructure of a carbonated supplementary cementitious material formed according to certain embodiments of the present invention.

FIG. 2 is a schematic illustration of a system for producing a carbonated supplementary cementitious material according to certain aspects of the present invention.

FIG. 3 is a plot of loss on ignition (LOI) vs. time for an Example of the present invention.

FIG. 4 is a plot of liquid to solid ratio (L/S) vs. time for an Example of the present invention.

FIG. 5 is a plot of viscosity vs. time for an Example of the present invention.

FIG. 6 is a plot of pH vs. time for an Example of the present invention.

FIG. 7 is a plot of slurry temperature versus time for an Example of the present invention. Note that the dip in temperature near the peak is due to a mixer issue.

FIG. 8 is a plot of particle size of the carbonatable starting material compared with the particle size of the starting material after carbonation for an Example of the present invention.

FIG. 9 are bar graphs showing compressive strength and strength activity index for 100% ordinary Portland cement and a mixture of ordinary Portland cement and carbonated supplementary cementitious materials.

FIG. 10 are plots of length change due to alkali-silica reactivity (ASR) of pure starting material (20%) of Solidia Cement without carbonation, Ordinary Portland cement without SCM, SCM slurry 25%+OPC 75%, and SCM slurry 35%+OPC 65%.

FIG. 11 is a reaction temperature profile as measured throughout the course of a carbonation reaction of a slurry according to additional aspects of the invention.

FIG. 12 is a plot of mass gain versus reaction time of the slurry of FIG. 11.

FIG. 13 is a plot of viscosity versus reaction time of the slurry of FIG. 11.

FIG. 14 is a plot of liquid-to-solid ratio and pH versus reaction time of the slurry of FIG. 11.

### DETAILED DESCRIPTION

Further aspects, features and advantages of this invention will become apparent from the detailed description which follows.

As used herein, the singular forms “a”, “an” and “the” are intended to include the plural forms as well, unless the context clearly indicates otherwise. Additionally, the use of “or” is intended to include “and/or”, unless the context clearly indicates otherwise.

As used herein, “about” is a term of approximation and is intended to include minor variations in the literally stated amounts, as would be understood by those skilled in the art. Such variations include, for example, standard deviations associated with techniques commonly used to measure the amounts of the constituent elements or components of an alloy or composite material, or other properties and characteristics. All of the values characterized by the above-described modifier “about,” are also intended to include the exact numerical values disclosed herein. Moreover, all ranges include the upper and lower limits.

Any compositions described herein are intended to encompass compositions which consist of, consist essentially of, as well as comprise, the various constituents identified herein, unless explicitly indicated to the contrary.

As used herein, the recitation of a numerical range for a variable is intended to convey that the variable can be equal to any value(s) within that range, as well as any and all sub-ranges encompassed by the broader range. Thus, the variable can be equal to any integer value or values within the numerical range, including the end-points of the range. As an example, a variable which is described as having values between 0 and 10, can be 0, 4, 2-6, 2.75, 3.19 - 4.47, etc.

In the specification and claims, the singular forms include plural referents unless the context clearly dictates otherwise. As used herein, unless specifically indicated otherwise, the word “or” is used in the “inclusive” sense of “and/or” and not the “exclusive” sense of “either/or.”

Technical and scientific terms used herein have the meaning commonly understood by one of skill in the art to which the present description pertains, unless otherwise defined. Reference is made herein to various methodologies and materials known to those of skill in the art.

Unless a specific methodology provided, the various properties and characteristics disclosed herein are measured according to conventional techniques familiar to those skilled in the art.

The base material used to form the supplementary cementitious materials of the present invention is not particularly limited so long as it is carbonatable. As used herein, the term “carbonatable” means a material that can react with and sequester carbon dioxide under the conditions described herein, or comparable conditions. The carbonatable material can be a naturally occurring material, or may synthesized from precursor materials.

In accordance with exemplary embodiments of the present invention, the carbonatable material can be formed from a first raw material having a first concentration of M that is mixed and reacted with a second raw material having a second concentration of Me to form a reaction product that includes at least one synthetic formulation having the general formula Mₐ Me_{b} O_{c}, Mₐ Me_{b} (OH)_{d}, Mₐ Me_{b} O_{c} (OH)_{d} or Mₐ Me_{b} O_{c} (OH)_{d}·(H₂O)ₑ , wherein M is at least one metal that can react to form a carbonate and Me is at least one element that can form an oxide during the carbonation reaction.

As stated, the M in the first raw material may include any metal that can carbonate when present in the synthetic formulation having the general formula Mₐ Me_{b} O_{c}, Mₐ Me_{b} (OH)_{d}, Mₐ Me_{b} O_{c} (OH)_{d} or Mₐ Me_{b} O_{c} (OH)_{d}·(H₂O)ₑ . For example, the M may be any alkaline earth element, preferably calcium and/or magnesium. The first raw material may be any mineral and/or byproduct having a first concentration of M. For example, the first raw material may include any one or more of the minerals listed in Table 1A. The first raw material may alternatively or further include any one or more of the byproducts listed in Table 1B.

TABLE 1A

Carbonates
Aragonite
Calcite
Dolomite
Magnesite
Gypsum
Marls
Talcs
Chlorites
Sulfates
Limestones
Calcium-Rich Biomass

TABLE 1B

Slags
Recycled Cement
Lime Kiln Dust (LKD)
Cement Kiln Dust (CKD)
Precipitated Calcium Carbonate
Recycled Paper
Flue Gas Desulfurization (FGD) Calcium Sulfate
Phosphogypsum
Silicon-Rich Biomass

As stated, the Me in the second raw material may include any element that can form an oxide by a hydrothermal disproportionation reaction when present in the synthetic formulation having the general formula Mₐ Me_{b} O_{c}, Mₐ Me_{b} (OH)_{d}, Mₐ Me_{b} O_{c} (OH)_{d} or Mₐ Me_{b} O_{c} (OH)_{d}(H₂O)ₑ. For example, the Me may be silicon, titanium, aluminum, phosphorus, vanadium, tungsten, molybdenum, gallium, manganese, zirconium, germanium, copper, niobium, cobalt, lead, iron, indium, arsenic, sulfur and/or tantalum. In a preferred embodiment, the Me includes silicon. The second raw material may be any one or more minerals and/or byproducts having a second concentration of Me. For example, the second raw material may include any one or more of the minerals listed in Table 1C. The second raw material may alternatively or further include any one or more of the byproducts listed in Table 1D.

TABLE 1C

Silicates
Zeolites
Shales
Slates
Clays
Argillites
Sandstones
Conglomerates
Basalts
Feldspars
Micas
Granites
Granodiorites
Diorites
Cherts
Sands
Amorphous Silicates

TABLE 1D

Flyash
Incinerator Dust
Fiberglass Cullet
Post and Pre-Consumer Glass
Mine Tailings
Rice Husk
Red Mud
Fresh and Salt Water Treatment Waste

In accordance with the exemplary embodiments of the present invention, the first and second concentrations of the first and second raw materials are high enough that the first and second raw materials may be mixed in predetermined ratios to form a desired synthetic formulation having the general formula Mₐ Me_{b} O_{c}, Mₐ Me_{b} (OH)_{d}, Mₐ Me_{b} O_{c} (OH)_{d} or Mₐ Me_{b} O_{c} (OH)_{d}·(H₂O)ₑ, wherein the resulting synthetic formulation can undergo a carbonation reaction. In one or more exemplary embodiments, synthetic formulations having a ratio of a:b between approximately 2.5:1 to approximately 0.167:1 undergo a carbonation reaction. The synthetic formulations can also have an 0 concentration of c, where c is 3 or greater. In other embodiments, the synthetic formulations may have an OH concentration of d, where d is 1 or greater. In further embodiments, the synthetic formulations may also have a H₂O concentration of e, where e is 0 or greater. Some exemplary, but non-limiting, examples of these embodiments of the synthetic formulations are shown in Tables 2A and 2B.

TABLE 2A
Calcium Silicate Hydrates

| | | | |
|---|---|---|---|
| Name | Formula | M/Mₑ | V % |

(a). Wollastonite group

| | | | |
|---|---|---|---|
| Foshagite | Ca₄(Si₃O₉)(OH)₂ | 1.33 | 52.12% |
| Hillebrandite | Ca₂(SiO₃)(OH)₂ | 2 | 45.98% |
| Nekoite | Ca₃Si₆O₁₅•7H₂O | 0.5 | −3.58% |
| Okenite | Ca₃Si₆O₁₅•6H₂O | 0.5 | 2.95% |
| Pectolite | Ca₂NaHSi₃O₉ | 1 | 14.57% |
| Xonotlite | Ca₆Si₆O₁₇(OH)₂ | 1 | 49.39% |

(b). Tobermorite group

| | | | |
|---|---|---|---|
| Clinotobermorite c | Ca₅Si₆O₁₇•5H₂O | 0.83 | 28.36% |
| Clinotobermorite d | Ca₅Si₆O₁₇•5H₂O | 0.83 | 28.36% |
| 'Clinotobermorite 9 Å'c | Ca₅Si₆O₁₆(OH)₂ | 0.83 | 56.20% |
| 'Clinotobermorite 9 Å'd | Ca₅Si₆O₁₆(OH)₂ | 0.83 | 56.25% |
| Oyelite | Ca₁₀B₂Si₈O₂₉•12.5H₂O | 1.25 | 19.66% |
| 9 Å tobermorite | Ca₅Si₆O₁₆(OH)₂ | 0.83 | 56.25% |
| (riversideite) c | | | |
| 9 Å tobermorite | Ca₅Si₆O₁₆(OH)₂ | 0.83 | 56.04% |
| (riversideite) d | | | |
| Anomalous 11 Å | Ca₄Si₆O₁₅(OH)₂•5H₂O | 0.67 | 13.91% |
| tobermorite c | | | |
| Anomalous 11 Å | Ca₄Si₆O₁₅(OH)₂•5H₂O | 0.67 | 13.91% |
| tobermorite d | | | |
| Normal 11 Å tobermorite d | Ca_{4.5}Si₆O₁₆(OH)•5H₂O | 0.75 | 17.55% |
| 14 Å tobermorite | Ca₅Si₆O₁₆(OH)₂•7H₂O | 0.75 | 17.55% |
| (plombierite) c | | | |
| 14 Å tobermorite | Ca₅Si₆O₁₆(OH)₂•7H₂O | 0.83 | 1.99% |
| (plombierite) d | | | |

(c). Jennite group

| | | | |
|---|---|---|---|
| Jennite | Ca₉Si₆O₁₈(OH)₆•8H₂O | 1.5 | 10.72% |
| Metajennite | Ca₉Si₆O₁₈(OH)₆•8H₂O | 1.5 | 19.67% |

(d). Gyrolite Group

| | | | |
|---|---|---|---|
| Fedorite | (Na, K)₂(Ca, Na)₇(Si, Al)₁₆O₃₈(F,OH)₂•3.5H₂O | 0.56 | 7.30% |
| Gyrolite | NaCa₁₆Si₂₃AlO₆₀(OH)₈•14H₂O | 0.67 | 13.30% |
| K-phase | Ca₇ Si₁₆O₃₈(OH)₂ | 0.44 | 26.57% |
| Reyerite | Na₂Ca₁₄Si₂₂Al₂O₅₈(OH)₈•6H₂O | 0.67 | 18.44% |
| Truscottitc | Ca₁₄Si₂₄O₅₈(OH)₈•2H₂O | 0.58 | 30.76% |
| Z-phase | Ca₉Si₁₆O₄₀(OH)₂•14H₂O | 0.56 | 7.06% |

(c) γ-C2S group

| | | | |
|---|---|---|---|
| Calcium chondrodite g | Ca₅[SiO₄]₂(OH)₂ | 2.5 | 63.78% |
| Kilchoanite | Ca₆(SiO₄)(Si₂O₁₀) | 1.5 | 75.76% |

(f) Other Calcium silicate phases

| | | | |
|---|---|---|---|
| Afwillite | Ca₃(SiO₃OH)₂•2H₂O | 1.5 | 30.42% |
| α-C₂SH | Ca₂(HSiO₄)(OH) | 2 | 47.12% |
| Cuspidine h | Ca₄(F_{1.5}(OH)_{0.5})Si₂O₇ | 2 | 67.86% |
| Dellaite | Ca₆(Si₂O₇)(SiO₄)(OH)₂ | 2 | 71.17% |
| Jaffeite | Ca₆[Si₂O₇](OH)₆ | 3 | 41.96% |
| Killalaite | Ca_{6.4}(H_{0.6}Si₂O₇)₂(OH)₂ | 1.6 | 65.11% |
| Poldervaartite i | Ca(Ca_{0.67}Mn_{0.33})(HSiO₄)(OH) | 2 | 26.10% |
| Rosenhahnite | Ca₃Si₃O₈(OH)₂ | 1 | 56.35% |
| Suolunite | CaSiO_{2.5}(OH)•_{0.5}H₂O | 1 | 33.02% |
| Tilleyite | Ca₃Si₂O₇(CO₃)₂ | 2.5 | 42.40% |

(g) Other high temperature cement phases

| | | | |
|---|---|---|---|
| Bicchulite | Ca₂(Al₂SiO₆)(OH)₂ | 0.67 | 54.71% |
| Fukalite | Ca₄(Si₂O₆)(CO₃)(OH)₂ | 2 | 41.40% |
| Katoite Hydrogarnet 1 | Ca_{1.46}AlSi_{0.55}O₆H_{3.78} | 0.30 | 71.13% |
| Rustumite | Ca₁₀(Si₂O₇)₂(SiO₄)Cl₂(OH)₂ | 2 | 60.83% |
| Scawtitem | Ca₇(Si₆O₁₈)(CO₃)•2H₂O | 1.17 | 43.03% |
| Stratlingite | Ca₂Al₂(SiO₂)(OH)₁₀•2.25H₂O | 0.62 | −32.08% |

TABLE 2B
Calcium Silicates

| | | | |
|---|---|---|---|
| Name | Formula | Ca/Si | V % |

(a). Nesosilicate Subclass (single tetrahedrons)

| | | | |
|---|---|---|---|
| Forsterite | Mg₂(SiO₄) | 2 | 99.85% |
| Andradite | Ca₃Fe³⁺₂(SiO₄)₃ | 0.6 | 51.80% |
| Grossular | Ca₃Al₂(SiO₄)₃ | 0.6 | 56.76% |
| Pyrope | Mg₃Ah(SiO4)₃ | 0.6 | 60.05% |
| Olivine | (Mg, Fe²⁺)₂(SiO₄) | 2 | 86.25% |
| Sphene/ | CaTiSiO₅ | 1 | 16.02% |
| Titanite | | | |
| Larnite | Ca₂SiO₄ | 2 | 80.36% |
| Hatrurite | Ca₃SiO₅ | 3 | 84.91% |
| (alite) | | | |

(b). Sorosilicate Subclass (double tetrahedrons)

| | | | |
|---|---|---|---|
| Danburite | CaB₂(SiO₄)₂ | 0.5 | 15.45% |

(c) Inosilicate Subclass (single and double chains)

| | | | |
|---|---|---|---|
| Augite | (Ca, Na)(Mg, Fe, Al, Ti)(Si, Al)₂O₆ | −0.5 | 36.56% |
| Diopside | CaMg(Si₂O₆) | 1 | 49.05% |
| Enstatite | Mg₂Si₂O₆ | 1 | 83.30% |
| Hedenbergite | CaFe² + Si₂O₆ | 0.33 | 35.84% |
| Hypersthene | MgFe²⁺Si₂O₆ | 1 | 32.18% |
| Rhodonite | (Mn²⁺, Fe²⁺, Mg, Ca)SiO₃ | 1 | 83.81% |
| Wollastonite 1A | CaSiO₃ | 1 | 65.51% |

(d). Cyclosilicate Subclass (rings)

| | | | |
|---|---|---|---|
| Cordierite | (Mg, Fe)₂Al₄Si₅O₁₈ | −0.22 | −8.48% |
| Osumilite (Mg) | (K, Na)(Mg, Fe²⁺)₂(Al, Fe³⁺)₃(Si, Al)₁₂O₃₀ | −0.167 | 4.69% |
| Osumilite (Fe) | (K, Na)(Mg, Fe²⁺)₂(Al, Fe³⁺)₃(Si, Al)₁₂O₃₀ | −0.167 | 1.92% |
| Pseudo-Wollastonite | Ca₃Si₃O₉ | 1 | 65.73% |

(e) Tectosilicate Subclass (frameworks)

| | | | |
|---|---|---|---|
| Andesine | (Na, Ca)(Si, Al)₄O₈ | −0.25 | 52.01% |
| Anorthite | CaAl₂Si₂O₈ | 0.25 | −6.85% |
| Bytownite | (Na, Ca)(Si, Al)₄O₈ | −0.25 | 50.70% |
| Labradorite | (Na, Ca)(Si, Al)₄O₈ | −0.25 | 51.35% |
| Oligoclase | (Na, Ca)(Si, Al)₄O₈ | −0.25 | 52.69% |

The synthetic formulation reacts with carbon dioxide in a carbonation process, whereby M reacts to form a carbonate phase and the Me reacts to form an oxide phase by hydrothermal disproportionation. In Tables 2A and 2B, the last column (V %) shows the calculated volume change when the exemplary synthetic formulations are carbonated (e.g. reacted with CO₂).

In an example, the M in the first raw material includes a substantial concentration of calcium and the Me in the second raw material contains a substantial concentration of silicon. Thus, for example, the first raw material may be or include limestone, which has a first concentration of calcium. The second raw material may be or include shale, which has a second concentration of silicon. The first and second raw materials are then mixed and reacted at a predetermined ratio to form reaction product that includes at least one synthetic formulation having the general formula (Ca_{w} Mₓ)ₐ (Si_{y},Me_{z})_{b} O_{c}, (Ca_{w} Mₓ)ₐ (Si_{y},M_{z})_{b} (OH)_{d}, or (Ca_{w} Mₓ)ₐ (Si_{y}Me_{z})_{b} O_{c} (OH)_{d}·(H₂O)ₑ, wherein M may include one or more additional metals other than calcium that can react to form a carbonate and Me may include one or more elements other than silicon that can form an oxide during the carbonation reaction. The limestone and shale in this example may be mixed in a ratio a:b such that the resulting synthetic formulation can undergo a carbonation reaction as explained above. As shown in Table 2A, the resulting synthetic formulation may be, for example, wollastonite, CaSiO₃, having a 1:1 ratio of a:b. However, for synthetic formulation where M is mostly calcium and Me is mostly silicon, it is believed that a ratio of a:b between approximately 2.5:1 to approximately 0.167:1 may undergo a carbonation reaction because outside of this range there may not be a reduction in greenhouse gas emissions and the energy consumption or sufficient carbonation may not occur. For example, for a:b ratios greater than 2.5:1, the mixture would be M-rich, requiring more energy and release of more CO₂. Meanwhile for a:b ratios less than 0.167:1, the mixture would be Me-rich and sufficient carbonation may not occur.

In another example, the M in the first raw material includes a substantial concentration of calcium and magnesium. Thus, for example, the first raw material may be or include dolomite, which has a first concentration of calcium, and the synthetic formulation have the general formula (Mgᵤ Caᵥ M_{w})ₐ (Si_{y},Me_{z})_{b} O_{c} or (Mgᵤ Caᵥ M_{w})ₐ (Si_{y},Me_{z})_{b} (OH)_{d}, wherein M may include one or more additional metals other than calcium and magnesium that can react to form a carbonate and Me may include one or more elements other than silicon that can form an oxide during the carbonation reaction. In another example, the Me in the first raw material includes a substantial concentration of silicon and aluminum and the synthetic formulations have the general formula (Caᵥ M_{w})ₐ (Alₓ Si_{y},Me_{z})_{b} O_{c} or (Caᵥ M_{w})ₐ (Alₓ Si_{y},Me_{z})_{b} (OH)_{d}, (Caᵥ M_{w})ₐ (Alₓ Si_{y},Me_{z})_{b} O_{c} (OH)_{d}, or (Caᵥ M_{w})ₐ (Alₓ Si_{y},Me_{z})_{b} O_{c} (OH)_{d}·(H₂O)ₑ.

Compared to Portland cement, which has an a:b ratio of approximately 2.5:1, the exemplary synthetic formulations of the present invention result in reduced amounts of CO₂ generation and require less energy to form the synthetic formulation, which is discussed in more detail below. The reduction in the amounts of CO₂ generation and the requirement for less energy is achieved for several reasons. First, less raw materials, such as limestone for example, is used as compared to a similar amount of Portland Cement so there is less CaCO₃ to be converted. Also, because fewer raw materials are used there is a reduction in the heat (i.e. energy) necessary for breaking down the raw materials to undergo the carbonation reaction.

Other specific examples of carbonatable materials consistent with the above are described in U.S. Pat. No. 9,216,926, which is incorporated herein by reference in its entirety.

According to further embodiments, the carbonatable material comprises, consists essentially of, or consists of various calcium silicates. The molar ratio of elemental Ca to elemental Si in the composition is from about 0.8 to about 1.2. The composition is comprised of a blend of discrete, crystalline calcium silicate phases, selected from one or more of CS (wollastonite or pseudowollastonite), C3 S2 (rankinite) and C2S (belite or larnite or bredigite), at about 30% or more by mass of the total phases. The calcium silicate compositions are characterized by having about 30% or less of metal oxides of Al, Fe and Mg by total oxide mass, and being suitable for carbonation with CO₂ at a temperature of about 30° C. to about 95° C., or about 30° C. to about 70° C., to form CaCO₃ with mass gain of about 10% or more. The calcium silicate composition may also include small quantities of C3S (alite, Ca₃SiO₅). The C2S phase present within the calcium silicate composition may exist in any α-Ca₂SiO₄, β-Ca₂SiO₄ or γ-Ca₂SiO₄ polymorph or combination thereof. The calcium silicate compositions may also include small quantities of residual CaO (lime) and SiO₂ (silica).

Calcium silicate compositions may contain amorphous (non-crystalline) calcium silicate phases in addition to the crystalline phases described above. The amorphous phase may additionally incorporate Al, Fe and Mg ions and other impurity ions present in the raw materials. The calcium silicate compositions may also include small quantities of residual CaO (lime) and SiO₂ (silica).

Each of these crystalline and amorphous calcium silicate phases may be suitable for carbonation with CO₂.

The calcium silicate compositions may also include quantities of inert phases such as melilite type minerals (melilite or gehlenite or akermanite) with the general formula (Ca,Na,K)_{2 [}(Mg, Fe²⁺,Fe³⁺, Al, Si)₃ O₇] and ferrite type minerals (ferrite or brownmillerite or C₄AF) with the general formula Cat (Al,Fe³⁺)₂ O₅. In certain embodiments, the calcium silicate composition is comprised only of amorphous phases. In certain embodiments, the calcium silicate comprises only of crystalline phases. In certain embodiments, some of the calcium silicate composition exists in an amorphous phase and some exists in a crystalline phase.

Each of these calcium silicate phases may be suitable for carbonation with CO₂. Hereafter, the discrete calcium silicate phases that are suitable for carbonation will be referred to as reactive phases. The reactive phases may be present in the composition in any suitable amount. In certain preferred embodiments, the reactive phases are present at about 50% or more by mass.

The various reactive phases may account for any suitable portions of the overall reactive phases. In certain preferred embodiments, the reactive phases of CS are present at about 10 to about 60 wt. %; C3 S2 in about 5 to 50 wt. %; C2S in about 5 wt. % to 60 wt. %; C in about 0 wt. % to 3 wt. %.

In certain embodiments, the reactive phases comprise a calcium-silicate based amorphous phase, for example, at about 40% or more (e.g., about 45% or more, about 50% or more, about 55% or more, about 60% or more, about 65% or more, about 70% or more, about 75% or more, about 80% or more, about 85% or more, about 90% or more, about 95% or more) by mass of the total phases. It is noted that the amorphous phase may additionally incorporate impurity ions present in the raw materials.

The calcium silicate compositions of the invention are suitable for carbonation with CO₂. In particular, the composition of calcium silicate is suitable for carbonation with CO₂ at a temperature of about 1° C. to about 99° C., or about 30° C. to about 95° C., or about 30° C. to about 70° C., to form CaCO₃ with mass gain. The mass gain reflects the net sequestration of CO₂ in the carbonated products.

It should be understood that, calcium silicate compositions, phases and methods disclosed herein can be adopted to use magnesium silicate phases in place of or in addition to calcium silicate phases. As used herein, the term “magnesium silicate” refers to naturally-occurring minerals or synthetic materials that are comprised of one or more of a groups of magnesium-silicon-containing compounds including, for example, Mg₂SiO₄ (also known as “forsterite”) and Mg₃Si₄O₁₀ (OH)₂ (also known as “talc”) and CaMgSiO₄ (also known as “monticellite”), each of which material may include one or more other metal ions and oxides (e.g., calcium, aluminum, iron or manganese oxides), or blends thereof, or may include an amount of calcium silicate in naturally-occurring or synthetic form(s) ranging from trace amount (1%) to about 50% or more by weight.

Other specific examples of carbonatable calcium silicate materials consistent with the above are described in U.S. Pat. No. 10,173,927, which is incorporated herein by reference in its entirety. According to one specific non-limiting example, the carbonatable calcium silicate material can have the following composition:

| Oxides | Wt. % |
|---|---|
| CaO | 42.5-46.5 |
| SiO₂ | 43.2-47.8 |
| Al₂O₃ | 2.5-6.0 |
| Fe₂O₃ | 0.8-2.5 |
| MgO | 0.8-2.0 |
| Na₂O | 0.1-0.5 |
| K₂O | 0.5-1.2 |
| SO₃ | 0.2-1.0 |

The carbonatable materials can be reacted with CO₂ (gas) in an aqueous slurry to create a crystalline calcium carbonate and an amorphous silica reaction product. In the case of carbonation directly from CO₂ the simplified reaction of the CO₂ with various non-limiting exemplary calcium silicate phases are shown in Equations 1-4.

CaSiO₃(s)+CO₂(aq)→CaCO₃(s)+SiO₂(s) (1)

Ca₃Si₂O₇(s)+3CO₂(aq)→3CaCO₃(s)+2SiO₂(s) (2)

Ca₂SiO₄(s)+2CO₂(aq)→2CaCO₃(s)+SiO₂(s) (3)

Ca₃SiO₅(s)+3CO₂(aq)→3CaCO₃(s)+SiO₂(s) (4)

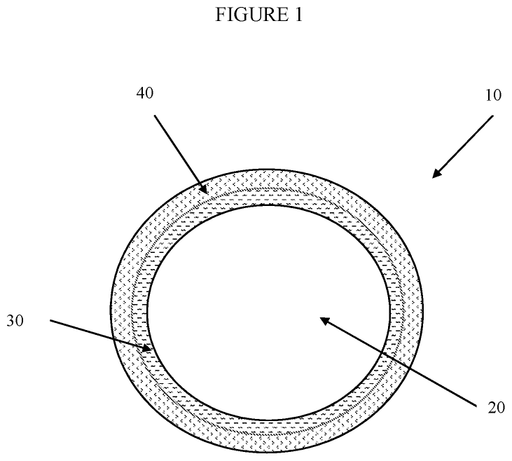

The abovementioned chemistries may be manifested in a number of possible microstructures or morphologies. For example, a plurality of bonding elements of one or more types of microstructure can be formed. One such microstructure (10) is schematically illustrated in FIG. 1 can be in the form a core (20) of an unreacted carbonatable phase of calcium and/or magnesium silicate fully or partially surrounded by a silica rich rim (30) that is fully or partially encased by a CaCO₃ layer (40).

The silica rich rim (30) generally displays a thickness, that can vary, typically ranging from about 0.01 μm to about 50 μm. In certain preferred embodiments, the silica rich rim has a thickness ranging from about 1 μm to about 25 μm. As used herein, “silica rich” generally refers to a silica content that is significant among the components of a material, for example, silica being greater than about 50% by volume of the rim. The remainder of the silica rich rim may be comprised largely of CaCO₃, for example 10% to about 50% of CaCO₃ by volume. The silica rich rim may also include inert or unreacted particles, for example 10% to about 50% of melilite by volume. A silica rich rim generally displays a transition from being primarily silica to being primarily CaCO₃. The silica and CaCO₃ may be present as intermixed or discrete areas.

The CaCO₃ layer (40) may optionally be in the form of discrete CaCO₃ particles.

Regardless of composition and microstructure, the carbonatable material of the present invention can be provided in the form of a powder having any suitable particle size and particle size distribution. For example, the powder can have a mean particle size (d50) of about 6 μm to about 30 μm, with 10% of particles (d10) sized below about 0.1 μm to about 3 μm, and 90% of particles (d90) sized below about 30 μm to about 150 μm as measured by laser diffraction analysis of a water suspension.

The carbonatable material of the present invention is reacted with carbon dioxide by a suitable technique, i.e., it is carbonated. According to certain exemplary embodiments, the carbonatable material, in the form of a powder, is combined with a significant amount of liquid to form a slurry. Then, a gas containing carbon dioxide, in a suitable concentration level, is bubbled through the slurry in a controlled manner so as to react with the carbonatable material contained in the slurry. As a result of the carbonation reaction, carbon dioxide is sequestered and the resulting carbonated material exhibits a gain in mass as a result. For example, the carbonated material may have a mass that is 10% to 25% greater than the uncarbonated precursor (carbonatable material).

According to certain embodiments, the liquid is composed entirely or partially of water. According to certain alternatives, the liquid is composed of a mixture of water and one or more solvents, such as methanol, ethanol, and/or isopropanol at 10 to 50% by weight replacement. Further, the slurry may optionally contain one or more additional additives, such as a dispersing agent (e.g., polycarboxlate ether (PCE), sugars); set retarding agents (e.g., sugars, citric acids and its salts); carbonation enhancing additives (e.g., acetic acid and its salts, vinegar etc.).

The relative amounts of carbonatable material to the amount of liquid used to form the slurry can comprise any suitable amounts. According to certain aspects, the weight ratio of liquid to solid of the slurry is at least about 1.0. According to further optional aspects, the weight ratio of liquid to solid of the slurry is about 1.0 to about 5.0, about 1.0 to about 3.0, or about 1.0 to about 1.5. According to one non-limiting example, the slurry is composed of about 1 part of solids and about 2.33 parts of water.

A gas containing carbon dioxide is introduced into the slurry. The gas can contain any suitable concentration of carbon dioxide. For example, the gas can contain 10%-100% carbon dioxide, by volume. The gas is introduced at a suitable flow rate. For example, that gas is introduced at a flow rate of about 100 to about 700 standard cubic feet per hour (SCFH), or about 100 to about 400 SCFH. Any suitable source of gas containing carbon dioxide can be used. For example, a number of suppliers of industrial gases offer tanked carbon dioxide gas, compressed carbon dioxide gas and liquid carbon dioxide, in a variety of purities. Alternatively, the carbon dioxide can be recovered as a byproduct from any suitable industrial process. As used herein, this source of carbon dioxide from the byproduct of an industrial process will be generally referred to as “flue gas.” The flue gas may optionally be subject to further processing, such as purification, before being introduced into the slurry. By way of non-limiting examples, the carbon dioxide can be recovered from a cement plant, power plant, etc.

While the gas is introduced into the slurry, the slurry is maintained at a suitable temperature. For instance, the slurry can be maintained at a temperature of about 1° C. to about 99° C., or about 30° C. to about 95° C., or about 30° C. to 70° C. Temperatures in these ranges promote a reaction with carbon dioxide, without requiring the use of excess energy.

Carbonation of cement is an exothermic reaction. Therefore, the heat of this reaction alone may suffice to achieve the target reaction temperature noted above. To the extent that the heat generated by the reaction is not sufficient to achieve the target reaction temperature, the slurry is heated by an external source of heat in order to reach the target reaction temperature.

The gas is introduced into the slurry for an appropriate amount of time to allow for reaction with the carbonatable material, and the resulting sequestration of carbon dioxide. The gas may be introduced into the slurry, for example, for 0.5-24 hours, 1-5 hours, 1-3 hours, or 1-2 hours.

After being allowed to react with the carbon dioxide containing gas for a suitable amount of time, a carbonated supplementary cementitious material is formed. Optionally, the carbonated supplementary cementitious material can be recovered from the slurry. Any suitable technique can be used to recover the carbonated supplementary cementitious material. For example, sedimentation and/or filtration can be utilized.

The carbonated supplementary cementitious material recovered from the slurry may optionally be subjected to a drying operation. According to nonlimiting examples, the recovered supplementary cementitious material can be dried at a temperature of 100° C. to 125° C. for a period of time of 5-24 hours, 1-5 hours, 1-3 hours, or 1-2 hours.

The dried carbonated supplementary cementitious material can optionally be subjected to one or more of deagglomeration and/or grinding steps. After the deagglomeration and/or grinding, the carbonated supplementary cementitious material can have any suitable particle size and particle size distribution measured by laser diffraction analysis. According to nonlimiting examples, the carbonated supplementary cementitious material can have a d₁₀=1-5 μm, a d₅₀=8-15 μm, and a d₉₀=35-90 μm.

The carbonated supplementary cementitious materials described in this disclosure may be integrated into or with a hydraulic cement composition or concrete mixture composition or clinker. The carbonated SCMs are added as a replacement of the hydraulic cement at a level of 1%-99%, by weight, replacement. The level of replacement of the hydraulic cement component of the binder system may be at suitable level, for example at 10% or more by mass of the total solid mass of the binder system (e.g., at about 10% or more, at about 20% or more, at about 30% or more, at about 40% or more, at about 50% or more, at about 60% or more, at about 70% or more, at about 80% or more, at about 90% or more, and optionally 99% or less, 90% or less, 80% or less, 70% or less, 60% or less, or 50% or less, by mass, of the total solids).

According to an alternative embodiment, after the slurry is allowed to react with the carbon dioxide containing gas for a suitable amount of time, the carbonated supplementary cementitious material is formed as a slurry. This slurry may then be added directly to the hydraulic cement-based composition or concrete mixture. Alternatively, as mentioned above, the slurry may be dried to form powder, then the powder added to cement-based composition or concrete mixture, and subjected to curing. Regardless of which route the carbonated supplementary cementitious material is combined with the hydraulic cement composition or concrete mixture composition, hydration of the hydraulic cement or concrete occurs whereby calcium silicate hydrate (C—S—H) is produced in addition to calcium hydroxide. The calcium hydroxide reacts with the amorphous silica from the carbonated supplementary cementitious material to produce additional C—S—H— a pozzolanic reaction.

When the carbonated supplementary cementitious material is added as a slurry, the solids content of the slurry is calculated to determine how much slurry should be added to reach the target replacement weight percentage addition of solid carbonated supplementary cementitious material. Also, addition of liquid from the slurry to the hydraulic cement or OPC mixture may also cause the amount of liquid used in the system to be adjusted, as appropriate.

A binder system created by the combination of a hydraulic cement and carbonated SCMs can form the binder component of a concrete body.

The hydraulic cement employed may be any hydraulic cements such as ordinary Portland cement (OPC), calcium sulfoaluminate cement, belitic cement, or other calcium based hydraulic material, or combinations thereof.

The binder system used in a concrete can alternatively be created by the intermixing of a powdered hydraulic cement and a carbonated SCMs at the site of concrete production. The binder can be combined with coarse and/or fine aggregates and water to produce a concrete appropriate for cast in place applications such as foundations, road beds, sidewalks, architectural slabs, and other cast in place applications. The binder can be combined with coarse and fine aggregates and water to produce a concrete appropriate for pre-cast applications such as pavers, CMUs, wet cast tiles, segmented retaining walls, hollow core slabs, and other pre-cast applications. The binder can be combined with fine aggregates and water to produce a mortar appropriate for masonry applications.

The concretes produced using the carbonated SCM containing binder can be produced with chemical admixtures common to the concrete industry such as, plasticizing, water reducing, set retarding, accelerating, air entraining, corrosion inhibiting, waterproofing, and efflorescence reducing admixtures.

The effectiveness of a binder system as described can be determined by calculation of the “activity index” of the synthetic pozzolan and activator combination. This is accomplished by measuring the mechanical properties (typically compressive strength) of a series of standard samples (typically mortars) with samples produced by various combinations of carbonated SCMs and hydraulic cement. The mechanical property measurement is then correlated with carbonated SCMs content of the mixture to determine an activity coefficient. An activity coefficient of 1 indicates parity in the property of the carbonated SCMs and the hydraulic cement being replaced. An activity coefficient greater than one indicates an improved performance of the carbonated SCMs over the hydraulic cement being replaced. An activity coefficient of less than one indicates that the carbonated SCMs contributes to the performance of the binder system, but at a lower level and the hydraulic cement being replaced. An activity coefficient of 0 indicates that the carbonated SCMs does not contribute to the performance of the binder system and is essentially an inert filler.

The principles of the present invention, as well as certain exemplary features and embodiments thereof, will now be described by reference to the following nonlimiting examples.

### EXAMPLES

### Example 1

### Replacement with Carbonated SCM Slurry

A carbonatable material was premixed with water to create a slurry with a significant amount of water (see Table 1 below). The material had the following composition:

| Oxides | Wt. % |
|---|---|
| CaO | 46.2 |
| SiO₂ | 43.3 |
| Al₂O₃ | 4.14 |
| Fe₂O₃ | 1.91 |
| MgO | 1.70 |
| Na₂O | 0.17 |
| K₂O | 0.58 |
| SO₃ | 1.24 |

Then, 100% CO₂ gas is bubbled through the slurry in controlled manner to form a carbonated SCM.

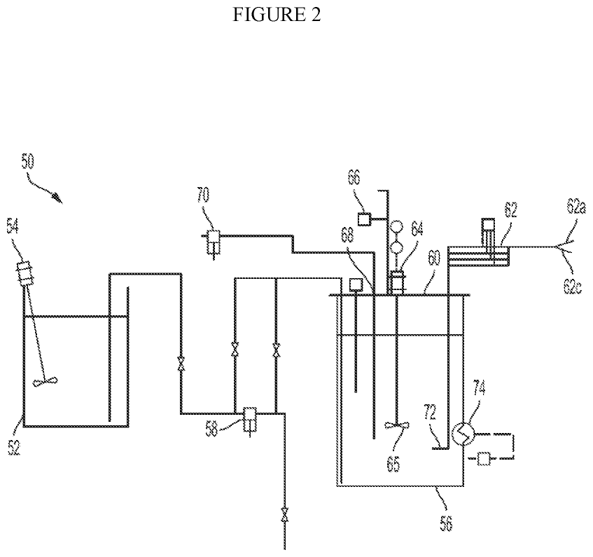

The carbonated SCM was synthesized using a pilot-scale test reactor system 50, as depicted in the schematic in FIG. 2. The above-described cement composition and water were mixed in one open 55-gallon drum 52 using a mixer 54. The mixture is pumped into a second 55-gallon drum 56 for carbonation by a transfer pump 58. The reactor drum 56 was sealed with a lid 60 which has all the reactor equipment attached: four baffles 62, a mixer 64 with a right-hand 10″ marine impeller 65, thermocouple 66, sampling port 68 with sampling pump 70, and the gas nozzles. Carbon dioxide gas was introduced to the system through the four baffles 62 having a branch 62a connected to an air supply and a branch 62c connected to a carbon dioxide supply, with 4¼″ pipe nozzles 72 positioned underneath the impeller 65. The reactor 56 has provided with a heated jacket 74.

Carbonated SCM was synthesized by bubbling carbon dioxide gas through a slurry with the parameters listed below in Table 1.

TABLE 1
SCM Synthesis run parameters

| Initial | Initial | CO₂ | | Mixer | |
|---|---|---|---|---|---|
| Liquid-to- | Solids | Volume | Reaction | Parameter, | |
| Solid | Loading, | Flow, | Length, | RPM; | |
| Ratio | % w/w | SCFH | hours | direction | Recovery |
| 1.44 | 41 | 400 | 24 | 460; CW | Slurry |

Samples were taken from the slurry at regular intervals during the reaction. Table 2 below shows the phase composition of the starting material and the final product (SCM Slurry). The X-ray diffraction (XRD) sample, taken at the end of the run, was dried at 35° C. Table 3 shows various slurry properties measured throughout the run. Liquid-to-solid ratio (L/S) was measured by drying a sample in the laboratory oven at 125° C. overnight. Loss on Ignition (LOI) was then performed using the methodology set forth in ASTM C114 on a sample of this dry material to determine the mass gain. LOI was calculated from the mass loss between 580° C. and 1000° C. Specific surface area (SSA) was measured using the BET method.

TABLE 2
Phase composition by X-ray diffraction

| | | | SCM |
|---|---|---|---|
| | | Starting | Slurry, |
| Phase | Formula | Material, % | % |
| Calcite | CaCO₃ | 0.9 | 40.6 |
| Akermanite- | Ca₂(Al, Mg)(Al, Si)₂O₇ | 17.2 | 15.2 |
| Gehlenite | | | |
| Rankinite | Ca₃Si₂O₇ | 27.6 | — |
| Pseudowollastonite | CaSiO₃ | 16.2 | 1.6 |
| Larnite | Ca₂SiO₄ | 2.2 | — |
| Quartz | SiO₂ | 2.4 | 1.5 |
| Cristobalite | SiO₂ | 1.2 | 1.3 |
| Amorphous | | 32.3 | 39.8 |

TABLE 3
SCM Slurry Properties at different times during the reaction

| Time, | LOI, | | Viscosity, | | SSA, | Particle Size, μm | | |
|---|---|---|---|---|---|---|---|---|
| Hours | % | L/S | cP | pH | m²/g | d10 | d50 | d90 |
| 0 | — | 1.44 | 100 | 11.3 | 2.28 | 1.57 | 13.10 | 51.18 |
| 1 | 6.2 | 1.31 | 272 | 9.36 | — | — | — | — |
| 4 | 8.5 | 1.29 | 764 | 9.07 | — | — | — | — |
| 6 | 10.9 | 1.25 | 1236 | 8.60 | — | — | — | — |
| 8 | 11.9 | 1.27 | 1187 | 8.65 | — | — | — | — |
| 24.5 | 19.0 | 1.08 | 1802 | 7.07 | 16.22 | 1.46 | 5.59 | 34.40 |

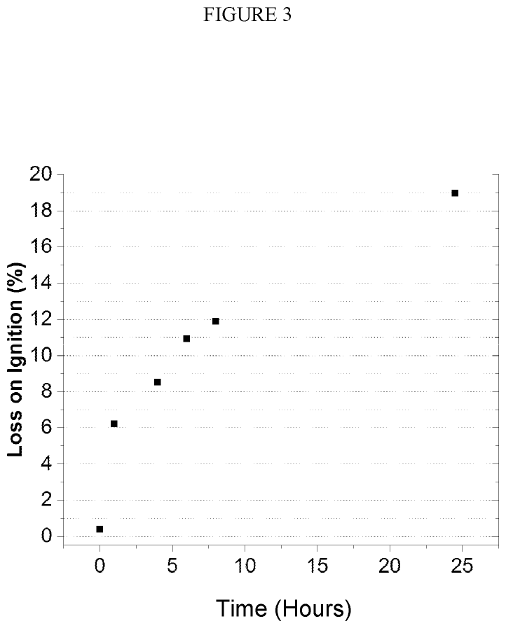

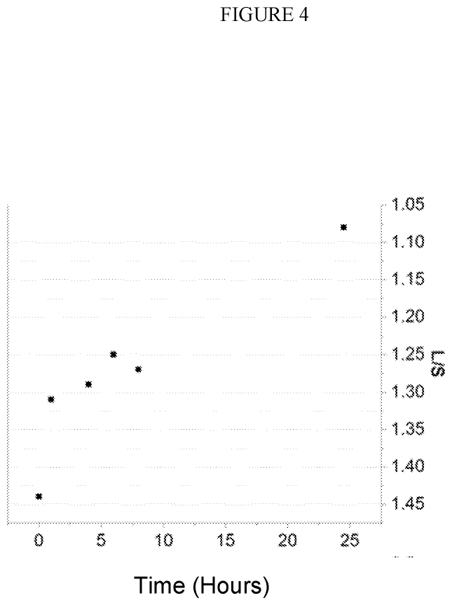

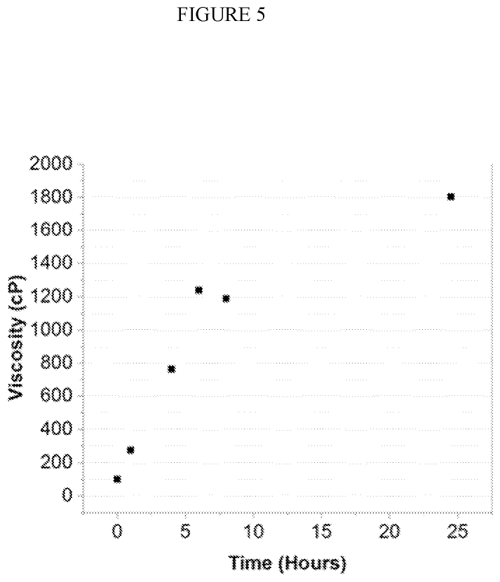

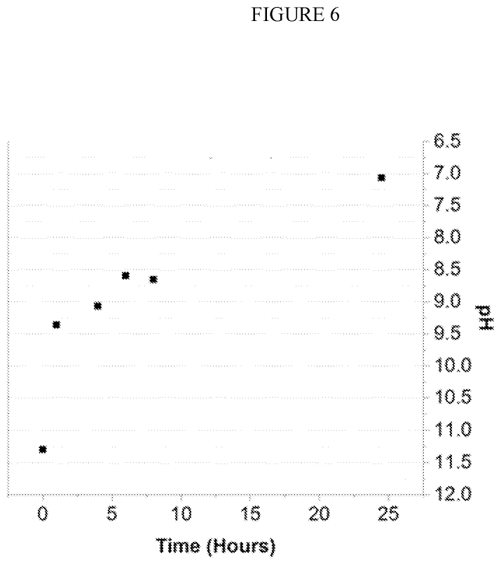

In FIGS. 3-6, LOI, L/S, viscosity, and pH are plotted as a function of time, respectively. L/S and pH are plotted on inverted y-axes to illustrate just how interrelated these properties are. The curves they form are nearly identical. Particle size distribution was measured using a laser diffraction analyzer in a water suspension.

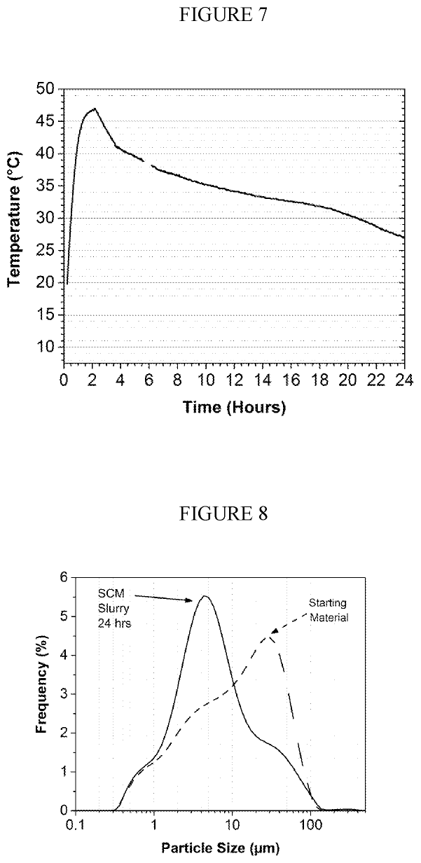

FIG. 7 shows the temperature of the slurry in the reactor as a function of time. The mixer tripped and turned itself off a few hours into the reaction, causing a slight drop in temperature.

FIG. 8 shows the particle size distribution of the SCM slurry product compared to the starting material. The bulk of the material generally gets finer during the reaction, and the shape of the curve gets slightly broader and more evenly shaped.

ASTM C311 and ASTM C618 Strength Activity Index

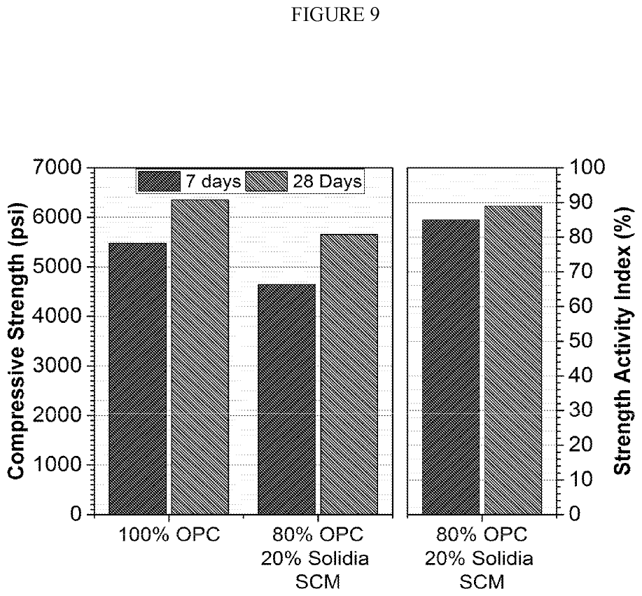

The ASTM C311 and ASTM C618 standards for fly ash and natural pozzolans calls for a minimum 7 and 28-day strength activity index (SAI) of 75%. The SAI is essentially the relative strength of a standard mortar cube with 20% of the Portland cement replaced with the SCM, compared to a similar 100% ordinary Portland cement mortar. As used herein the replacement percentages are weight percentages, based on the weight of the Portland cement. Thus, for example, a 20% replacement of a 100 g sample of OPC would involve creating a mixture of 80 g OPC solids and 20 g of SCM solids. In these examples the SCM was added in slurry form. Thus, the solids content of the slurry was determined, and the amount of slurry necessary to contribute the desired replacement amount of SCM solids was added. The 7-day data for this is shown in Table 4 and plotted in FIG. 9. Achieving 85% of control strength in 7 days with a 20% replacement indicates there is a 5% increase in strength, which is indicative of pozzolanic activity, and meets the ASTM requirement of 75%. Table 4—Strength Activity Index for Carbonated Slurry SCM:

| Time, | OPC, | 20% SCM | Relative Strength |
|---|---|---|---|
| days | psi | Slurry, psi | (SAI), % |
| 7 | 5474 | 4645 | 85 |
| 28 | 6354 | 5652 | 89 |

ASTM C1567 ASR Test

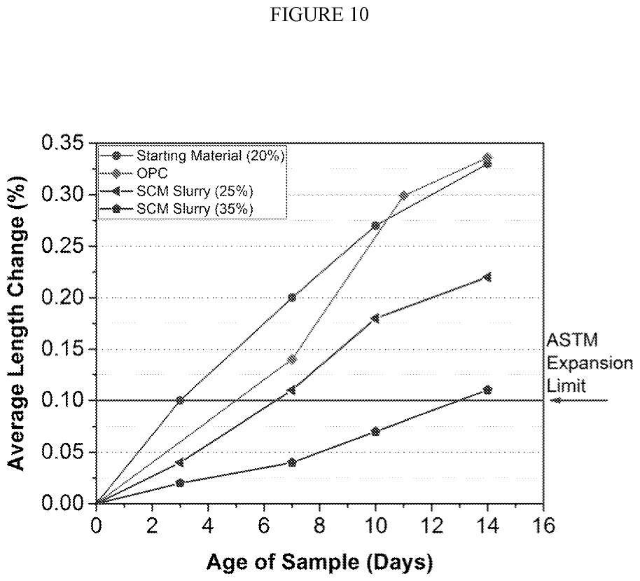

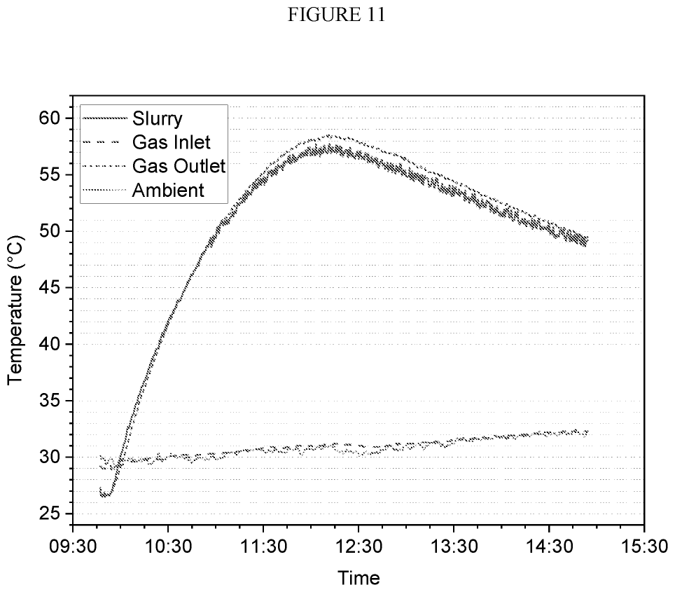

The ASTM C1567 standard test method for determining potential alkali-silica reactivity (ASR), states that expansion greater than 0.10% in 14 days is indicative of potentially deleterious expansion. This expansion data is tabulated below in Table 5 for a 100% OPC mix as well as 20% replacement of the starting material (OPC) and 25 and 35% replacements of the starting material with the SCM slurry product. This data is also plotted in FIG. 10. The 35% replacement with SCM is very close to passing this ASR test, and at 45% replacement it passes the ASR tested according to ASTM C1567.

TABLE 5
Expansion due to ASR

| | Starting Material | 100% | SCM Slurry | SCM Slurry |
|---|---|---|---|---|
| | (20%) | OPC | (25%) | (35%) |
| Days | % | % | % | % |
| 0 | 0 | 0 | 0 | 0 |
| 3 | 0.1 | — | 0.04 | 0.02 |
| 7 | 0.2 | 0.14 | 0.11 | 0.04 |
| 10 | 0.27 | — | 0.18 | 0.07 |
| 11 | — | 0.299 | — | — |
| 14 | 0.33 | 0.336 | 0.22 | 0.11 |

From the above, it can be seen that LOI, L/S, Viscosity, and pH are all very good indicators of the state of the slurry. The carbonated SCM achieved 89% of control strength in 28 days with a 20% replacement, which is indicative of pozzolanic activity, and meets the ASTM C311 requirement. Carbonated SCM, at a replacement level of 35%, nearly meets the ASTM C1567 requirement for expansion due to ASR, with an expansion of 0.11% in 14 days.

### Example 2

### Replacement with Carbonated Dried SCM Powder

A cement was premixed with water to create a slurry. The cement had the same composition as the cement of Example 1. The slurry was carbonated in a reactor having the same features as that of Example 1. Carbonated SCM was synthesized by bubbling carbon dioxide gas through a slurry with the parameters listed below in Table 6.

TABLE 6
SCM Synthesis run parameters

| Initial | Initial | CO₂ | | Mixer | |
|---|---|---|---|---|---|
| Liquid-to- | Solids | Volume | Reaction | Parameter, | |
| Solid | Loading, | Flow, | Length, | RPM; | |
| Ratio | % w/w | SCFH | hours | direction | Recovery |
| 2.33 | 30 | 400 | 5 | 350; CCW | Dried |
| | | | | | Slurry |

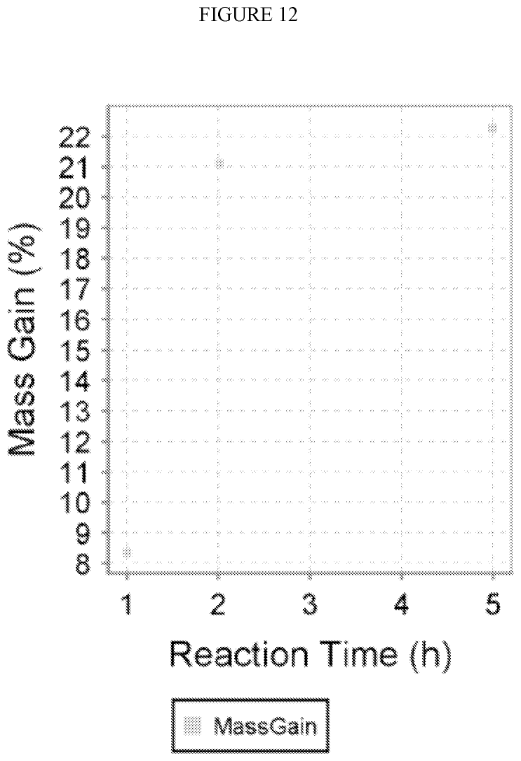

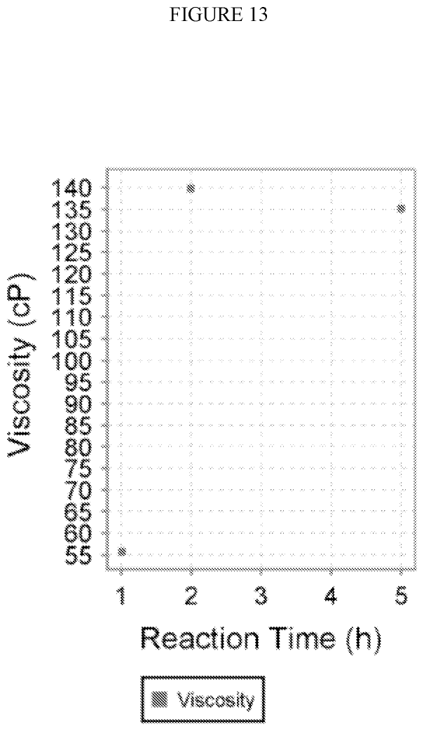

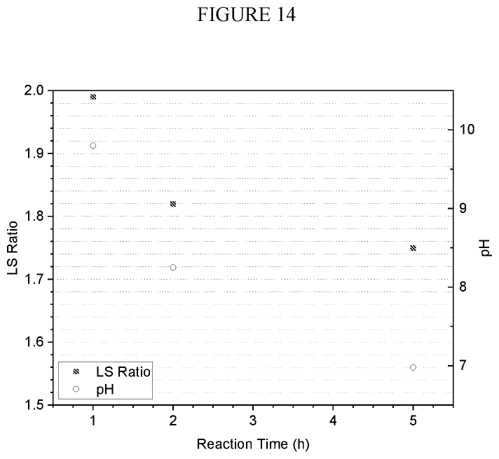

Samples were taken from the slurry at regular intervals during the reaction. FIG. 11 is a reaction temperature profile as measured throughout the course of the carbonation reaction. FIG. 12 is a plot of mass gain versus reaction time. FIG. 13 is a plot of slurry viscosity versus reaction time. FIG. 14 is a plot of liquid-to-solid ratio and pH versus reaction time. Liquid-to-solid ratio (L/S) was measured by drying a sample in the laboratory oven at 125° C. overnight. Loss on Ignition (LOI) was then performed on a sample of this dry material to determine the mass gain. Mass gain was calculated from the mass loss between 580° C. and 1000° C.

After the slurry was dried into a powder at 125° C. overnight, the resultant powder SCM was tested in mortar for compressive strength using 20%, 35%, and 50% replacement levels at 7 and 28 days in the same manner as done in Example 1. The strength activity index (SAI) was calculated by dividing the average compressive strength of the test cubes by the average compressive strength of the pure OPC control cubes. See the mortar flow and compressive strength data in table below. Note that the pure OPC control samples had a water-to-cement ratio (W/C) of 0.485. The test mixes needed more water to achieve the same level of flow as the pure OPC. However, despite this increase in W/C, both the 20% and 35% replacements matched the strength of the control after 28 days, as set forth in Table 7 below.

TABLE 7

| | | | | | 7 Day | 7 Day | 28 Day | 28 Day | | |
|---|---|---|---|---|---|---|---|---|---|---|
| Cement | Control | Sample | Sample | % Water | Control | Sample | OPC | Sample | 7 Day | 28 Day |
| Repl. Level | Flow | Flow | W/C | Increase | Strength | Strength | Strength | Strength | SAI % | SAI % |
| 20% | 172 | 165 | 0.495 | 2.06 | 3694.42 | 3644.46 | 5115 | 5142 | 98.65 | 100.53 |
| 35% | 172 | 169 | 0.525 | 8.25 | 3694.42 | 3006.95 | 5115 | 5004 | 81.39 | 97.83 |
| 50% | 172 | 166 | 0.545 | 12.37 | 3694.42 | 2559.50 | 5115 | 3785 | 69.28 | 74.00 |

In view of the above, it will be seen that the several advantages of the invention are achieved and other advantages attained.

As various changes could be made in the above methods and compositions without departing from the scope of the invention, it is intended that all matter contained in the above description shall be interpreted as illustrative and not in a limiting sense.

Any numbers expressing quantities of ingredients, constituents, reaction conditions, and so forth used in the specification are to be interpreted as encompassing the exact numerical values identified herein, as well as being modified in all instances by the term “about.” Notwithstanding that the numerical ranges and parameters setting forth, the broad scope of the subject matter presented herein are approximations, the numerical values set forth are indicated as precisely as possible. Any numerical value, however, may inherently contain certain errors or inaccuracies as evident from the standard deviation found in their respective measurement techniques. None of the features recited herein should be interpreted as invoking 35 U.S.C. § 112, paragraph 6, unless the term “means” is explicitly used.

We claim:

1. A method of making a supplementary cementitious material comprising:
forming a slurry comprising water and a carbonatable material powder, wherein a weight ratio of water to the carbonatable material powder in the slurry is at least 1; and
flowing a gas comprising carbon dioxide into the slurry for 0.5 to 24 hours while maintaining the slurry at a temperature of 1° C. to 99° C. to form a carbonated slurry comprising CaCO₃ and amorphous silica.

2. The method of claim 1, wherein the carbonatable material powder includes at least one synthetic formulation having the general formula Mₐ Me_{b} O_{c}, Mₐ Me_{b} (OH)_{d}, Mₐ Me_{b} O_{c} (OH)_{d} or Mₐ Me_{b} O_{c} (OH)_{d}·(H₂O)ₑ, wherein M is at least one metal that can react to form a carbonate and Me is at least one element that can form an oxide during the carbonation reaction.

3. The method of claim 2, wherein M is calcium and/or magnesium.

4. The method of claim 3, wherein Me is silicon, titanium, aluminum, phosphorus, vanadium, tungsten, molybdenum, gallium, manganese, zirconium, germanium, copper, niobium, cobalt, lead, iron, indium, arsenic, sulfur and/or tantalum.

5. The method of claim 4, wherein Me is silicon.

6. The method of claim 2, wherein a ratio of a:b is about 2.5:1 to about 0.167:1, c is 3 or greater, d is 1 or greater, e is 0 or greater.

7. The method of claim 1, wherein the carbonatable material powder comprises calcium silicate having a molar ratio of elemental Ca to elemental Si of about 0.8 to about 1.2.

8. The method of claim 7, wherein the carbonatable material powder comprises a blend of discrete, crystalline calcium silicate phases, selected from one or more of CS (wollastonite or pseudowollastonite), C3 S2 (rankinite) and C2S (belite or larnite or bredigite), at about 30% or more by mass of the total phases, and about 30% or less of metal oxides of Al, Fe and Mg by total oxide mass.

9. The method of claim 8, wherein the carbonatable material powder further comprises an amorphous calcium silicate phase.

10. The method of claim 1, wherein the carbonatable material powder has a mean particle size (d50) of about 6 μm to about 30 μm, with 10% of particles (d10) sized below about 0.1 μm to about 3 μm, and 90% of particles (d90) sized below about 30 μm to about 150 μm.

11. The method of claim 1, wherein the weight ratio of water to the carbonatable material powder is 1.0-5.0.

12. The method of claim 1, wherein the weight ratio of water to the carbonatable material powder is 1.0-3.0.

13. The method of claim 1, wherein the gas comprises 10%-100% carbon dioxide, by volume.

14. The method of claim 1, wherein the gas is flowed into the slurry at a rate of 100 to 600 SCFH.

15. The method of claim 1, further comprising:
drying the carbonated slurry at a temperature of 60° C. to 125° C. for 5 to 24 hours.

16. The method of claim 15, further comprising:
subjecting the dried carbonated slurry to one or more of deagglomeration and grinding to form the supplementary cementitious material.

17. The method of claim 1, wherein the gas comprising carbon dioxide is obtained from a flue gas.

18. A method for forming cement or concrete, the method comprising:
forming a supplementary cementitious material according to the method of claim 1;
combining the supplementary cementitious material with a hydraulic cement composition to form a mixture, wherein the mixture comprises 1%-99%, by weight, of the supplementary cementitious material, based on the total weight of solids in the mixture; and
reacting the mixture with water to form the cement or concrete.

19. The method of claim 18, wherein the mixture comprises 20%-35% of the supplementary cementitious material by weight, based on the total weight of solids in the mixture.

20. The method of claim 18, wherein the hydraulic cement comprises one or more of ordinary Portland cement, calcium sulfoaluminate cement, belitic cement, or other calcium based hydraulic material.

21. The method of claim 18, further comprising adding aggregate to the mixture.

22. The method of claim 18, wherein the step of reacting the mixture with water to form the cement or concrete comprises reacting amorphous silica in the supplementary cementitious material with the hydraulic cement composition.

23. The method of claim 22, wherein the reaction of amorphous silica in the supplementary cementitious material with the hydraulic cement composition comprises reacting calcium hydroxide with the amorphous silica from the carbonated supplementary cementitious material to produce calcium silicate hydrate.
